(19) United States
(12) Patent Application Publication
(10) Pub. No.: US 2019/0367141 A1
(43) Pub. Date: Dec. 5, 2019

(54) REMOTE OR AUTOMATIC MONITOR AND CONTROL FOR A DOCK MOVER

(71) Applicants: Lester Lee Ramey, Clayton, GA (US); Richard Hardy Dawkins, Martin, GA (US)

(72) Inventors: Lester Lee Ramey, Clayton, GA (US); Richard Hardy Dawkins, Martin, GA (US)

(21) Appl. No.: 15/991,564

(22) Filed: May 29, 2018

(51) Int. Cl. B63C 1/02; H04N 7/18

(52) U.S. Cl. CPC B63C 1/02; B63B 2035/007; H04N 7/185

(57) ABSTRACT

An automated floating dock system is provided having a controller for controlling the repositioning of a floating dock. The system can be controlled remotely using a controller device. The system may also have sensors and controls that will automatically report sensor condition and perform necessary functions to relocate a floating dock.

### TECHNICAL FIELD

This invention relates generally to a floating dock mover, and more particularly to a new and useful method to relocate a floating dock in relation to a shoreline by an automatic monitor and control.

### BACKGROUND

It is a common necessity of floating dock owners, and property caretakers of lake front property to periodically relocate a dock in relation to the shoreline due to changing water levels. On many lakes and reservoirs in the United States the water level changes frequently. With water level changes, the shoreline in relation to a floating dock changes, thereby requiring relocation of the dock. If the dock isn't relocated, it can become inaccessible and therefore unusable.

When the water level in the lake or reservoir decreases, the shoreline moves outward away from the main body of water. The dock can become beached if it's not relocated accordingly inward toward the body of water. When water level rises, the shoreline changes toward the beach. The dock will need to be relocated toward the beach or it can become isolated. When it becomes isolated, there is no access to the dock without going through water.

Thus, it is desirable to maintain the floating dock at a relative fixed distance from the moving shoreline so the end of the dock walkway is supported by, and accessed by dry land and the entirety of dock be in water deep enough to allow boats and other recreational vehicles easy access to the dock and main body of water. This requires dock movement to be both horizontally and vertically to changes in the water level.

Floating docks are typically held in place in relation to a shoreline by means of cables and shore anchor points. Typically, there are two anchor cable assemblies, one on each dock corner closest to the shore. The shore anchor points are secured above the high water level. Typically, hand operated winches are attached to the dock and used to control the length of anchor cables, thereby controlling the distance from the shore.

Accordingly, several objects and advantages of the embodiment of this floating dock mover are: a) To provide a vast improvement over prior art in design, construction, and ease of use to relocate a floating dock assembly both vertically and horizontally when lake or reservoir water level increases and decreases; b) a method to electrically power an anchor mechanism for the dock assembly when a desired new location is achieved; c) to provide an electrically powered method to raise and lower a walkway ramp attached to the end of a dock walkway.

Additional objects and advantages will become apparent from a consideration of the ensuing summary, description, and drawings.

### SUMMARY OF THE INVENTION

The present invention relates to a combination of devices for remote control or automating the relocation of a floating dock whenever water level increases or decreases in a lake or reservoir. In one embodiment, an automated process for detecting sensor conditions by a controller to initiate the movement of a dock. Changes in water level causes the shoreline to change accordingly. To continue to be usable, the floating dock must maintain a relative constant distance from the shoreline. When water level decreases, the shoreline moves inward toward the main body of water and the floating dock should be moved in or it will become beached. When water level increases, the shoreline moves away from the main body of water and the floating dock should be moved out from the body of water toward the shoreline or it will become isolated by water.

In another exemplary embodiment, a user may monitor the location of the dock using alive feed on a controller device and control the movement manually by way of an application on a phone or remote electronic device. It is the goal of the present invention to maintain a floating dock at a more or less constant position and orientation relative to a moving shoreline.

### BRIEF DESCRIPTION OF DRAWINGS

Reference will now be made to the accompanying drawings, which are not necessarily drawn to scale, and wherein:

FIG. 1 is an exemplary block diagram of an automated dock mover system according to the invention;

FIG. 2 is an exemplary block of one embodiment a remote access according to this invention; and

FIG. 3 is an exemplary diagram of a controller device according to this invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENT OF THE INVENTION

In the following paragraphs, example embodiments will be described in further detail with reference to the figures. In the description, well-known components, methods and or processing techniques are omitted or briefly described. Furthermore, various feature(s) of the embodiments is not to suggest that all embodiments must include the references feature(s).

The inventors incorporate herein by reference any and all U.S. patents, U.S. patent applications, and other documents cited or referred to in this application or cited or referred to in the U.S. patents and U.S. patent applications. The general operation of a dock mover system according to this invention is published as U.S. Pat. Nos. 8,596,211 and 9,233,735, the entire disclosure of which is incorporated herein by reference.

The present invention comprises of a combination of cameras, sensors, and/or local control devices interfaced to a floating dock, and electrically connected stand alone or by a local wired or a wireless network. This network of electrical/electronic cameras, sensors, and control devices are interfaced to an outside communication system that will allow a user skilled in the operation of the device to monitor, and control a position of a floating dock.

The cameras, and/or sensors, and/or controlling devices may be locally connected via wired or wireless systems by direct connect, Bluetooth, LAN, Z-wave, ZigBee, Wi-Fi, cell phone protocols (ex: GSM and CDMA), RS232, RS485, etc. protocols, or other wired and wireless protocols, and connected remotely via LAN, WAN, phone, Internet, satellite, dedicated electronic devices, or other electronic long distance means of wired or wireless system.

The present invention may also be automatically monitored and perform function(s) automatically by way of sensing conditions and actuating motors and or pulleys to move the dock. The system may then check state of sensors, and furthermore may be setup to the condition or action results to the user. If the sensor(s) condition isn't satisfied, the action may continue as the sensor(s) and software directs.

The present invention may also allow the user to use a process of using wireless or wired interface system such as a phone app, computer app, or other computer system/software, or dedicated electronic interface device to remotely sense, monitor, and/or control a dock mover and/or reposition it in relation to a shoreline. This invention provides an easy to operate and useful means of relocating a dock. This would allow a user to be able to view and/or get notifications that a dock needs moved in relation to a shoreline. A user may be many miles away and view and operate remotely controlled devices, or have the dock mover sensed a need and perform a function(s) without operator input. Sensors, camera views, satisfied conditions, and/or alarm conditions may be reported to a user. The remote control can be by means of computers, smart phones, and/or other electronic control devices. There is a need to be able to get notifications, view, monitor, and/or control a dock mover remotely, and/or to have a dock mover system that would sense and perform the function(s) automatically.

In the following description of exemplary embodiments, for purposes of explanation and not limitation, specific details are set forth, such as specific controller and network device configurations, to provide a thorough understanding of the present disclosure. It will be apparent to one skilled in the art that the technique presented herein may be practiced in other embodiments that depart from these specific details.

Moreover, those skilled in the art will further appreciate that the methods, steps and functions discussed herein may be implemented using individual hardware circuitry, using software functioning in conjunction with a programmed microprocessor or a general purpose computer, or PLC, using one or more Application Specific Integrated Circuits (ASICs), one or more Digital Signal Processors (DSPs) and/or one or more Field Programmable Gate Arrays (FPGAs). It will also be appreciated that the methods, steps and functions disclosed herein may be embodied in a processor and a memory coupled to the controller, wherein the memory stores one or more programs that perform the steps discussed herein when executed by the controller.

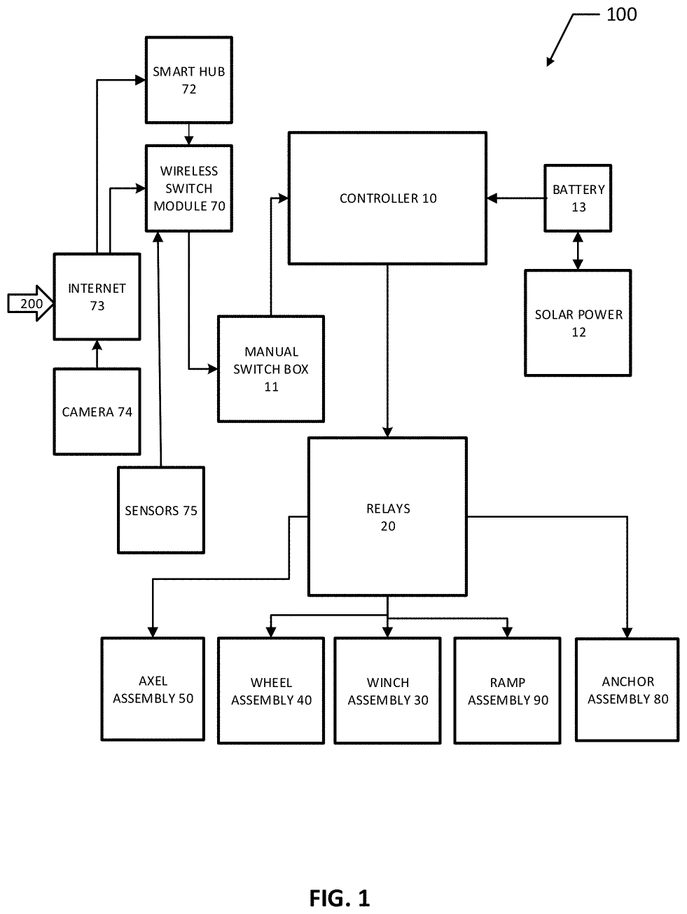

Turning now to the figures, particular embodiments are described. FIG. 1 illustrates an automated dock mover system 100 according to an example embodiment. The automated dock mover system 100 is designed to be integrated with a dock mover, such as those described in U.S. Pat. Nos. 8,596,211 and 9,233,735. The automated dock mover system 100 may provide systems and methods for moving a floating dock in relation to a shoreline. The view of the first embodiment shows a controller 10. The controller 10 is the main controller of the dock mover system 100. Based on instructions sent by it, it send commands to the relays 20, which in turn powers and/or actuates the axel assembly 50, the wheel assembly 40, the winch assembly 30, the ramp assembly 90, and the anchor assembly 80 to cause repositioning of the dock to align it with a shoreline and to anchor the dock at the selected position. The solar power array 12, or utility power, and/or the battery 13 provides power to the controller 10.

In some example embodiments, the automated dock mover system 100, the controller 10 is in communication a manual switch box 11, as generally illustrated in FIG. 1. The manual switch box 11 is in communication with wireless switch module 70. The wireless switch module 70 is in communication with sensors 75, internet 73, and a smart hub 72. Both the smart hub 72 and wireless switch modules 70 may be powered by a 115 VAC power source or utility power (not shown). The smart hub 72 is connected to a remote access point 200 via the internet 73. Cameras 74 are also in communication with the smart hub 72 via the internet 73.

In some exemplary embodiments, in an automated means, the sensors 75 can be any of a visual sensor, a water level sensor, proximity or location sensor to provide status and monitoring data of conditions related to the location of a dock to the controller 10, through the wireless switch module 70. The controller 10 may use this status and monitoring data to actuate the manual switches 11 to cause the live axel 50 to move the dock in a direction until the status and monitoring conditions of the sensors 75 are met. For example, using a water level sensor, which may be located at the shoreline end of a dock, controller 10 may periodically monitor status conditions of the water level sensor. Once the controller 10 detects that the water level sensor is no longer detecting water levels adequate for conditions (the dock is not in deep enough water). This indicates that the lake levels are low, and that the dock needs to be relocated further out towards the water. The controller 10 would initiate movement conditions for the winch assembly 30 and the axel assembly 40 to release and to lift the anchor assembly 80, lift the ramp assembly 90, and drive the live axel 50 in the direction of the water line until the water sensor's conditions are met. Any combination of sensors 75 can be used to operate this condition. For example, the controller 10 may monitor the status of the proximity and visual sensors. And therefore, once the proximity and visual sensor indicates that its conditions are no longer met, and the controller can then automatically initiate the movement conditions of the dock in the same manner as described above.

A user of the automated dock mover system 100 may access and monitor the movement conditions by way of remote access 200 and camera 74. Camera 74 is intended to provide a live feed to the user such that the user can monitor the movement conditions to ensure that the dock is being moved to the correct location and that the dock is safe to move. The camera 74 can be located on the dock itself or in an overlooking location to the dock.

Upon reaching the new desired position, through a preprogrammed sequence of operations, the controller 10 would then lower ramp assembly 90 causing it to contact a beach area. Anchor assembly 80 will extend downward and into the beach area. Next, the process tighten winch assembly 30 and lock the wheel assembly 40. Finally, the ramp assembly 90 can be lowered to provide access to the shoreline.

Thus the reader will see this invention, a floating dock mover does provide an easy to use, efficient, and desirable means to relocate a dock both horizontally and vertically in relation to a moving shoreline as water level changes.

While the above description contains many specificities, these should not be constructed as limitations on the scope of the invention, but rather as an exemplification of one preferred embodiment thereof. Many other variations are possible. Examples are as follows: The electrical power sources may be AC or DC voltage. It may also be powered by solar power.

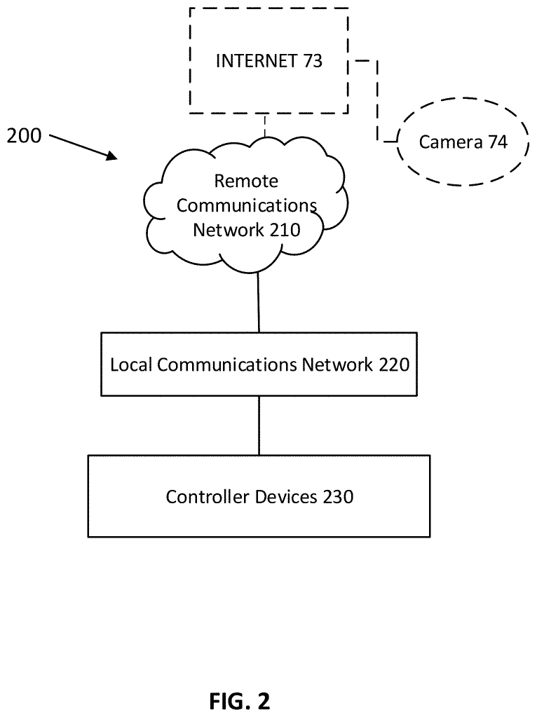

Turning now to FIG. 2, FIG. 2 is a block diagram illustrating one of a number of possible embodiments of a remote access 200 according to the present invention. Remote access 200 is a virtual private network (VPN) that extends the remote communications network 210 across a public network, and enables users to send and receive data across shared or public networks as if their controller devices 230 were directly connected to the automated dock mover system 100 of FIG. 1. Signals from controller devices 230 sent through the remote communications network 210 to the automated dock mover system 100 may therefore benefit from the functionality, security, and management of the remote communications network 210.

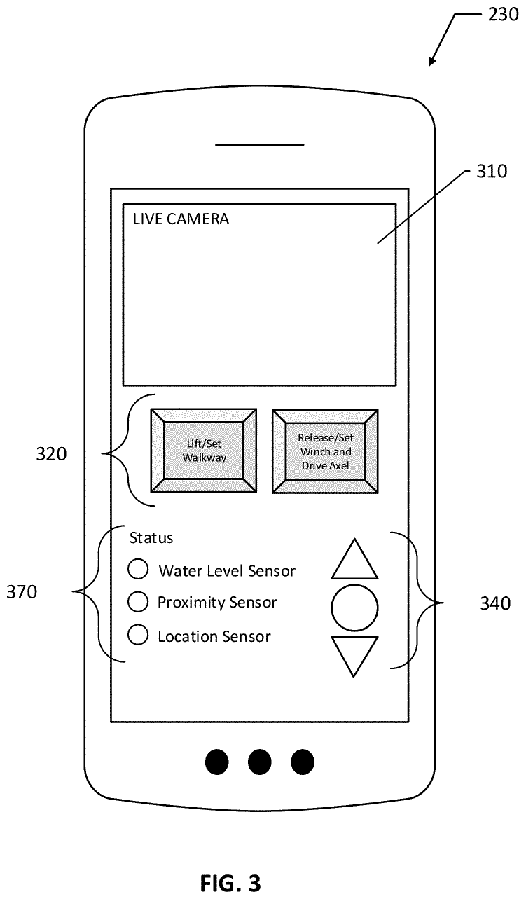

The remote access 200 allows the user to securely access the automated dock mover system 100 as if they were directly connected to the system. The remote access 200 establishes a virtual point-to-point connection between the controller devices 230 and the automated dock mover system 100 through the use of dedicated connections, virtual tunneling protocols, and/or traffic encryption. From a user perspective, the functions of controller 10 of the automated dock mover system 100 can be accessed remotely. Communication to and from the automated dock mover system 100 of FIG. 1 is provided between the remote communications network 210 through the internet 73. Cameras 74 are also in communication with the remote network 210, through the remote access 200 and the automated dock mover system 100 to provide live feeds of the dock to the user on the controller device 230. A user may use the controller device 230 to see a live feed from the camera 74, monitor the status conditions of the sensors 75 and to initiate commands to move the relocate the dock in accordance with the embodiments herein. A local communications network 220 may also be employed to facilitate communication from the controller device 230 to the remote communications network 210. An exemplary controller device 230 is described with respect to FIG. 3.

Reference is now made to FIG. 3, which illustrates an exemplary control device 230 for interfacing and controlling the functions an automated dock system 100. Shown here is a mobile phone running a mobile application. The mobile phone is a mobile broadband device, such as those sold under the trade names IPhone, IPad Android, HTC Smartphone or other Smartphone or PDAs of the type sold by Samsung, Apple, Blackberry or the like. Using the phone's platform, i.e. Android® for example, status alerts may be presented directly on the display via the phone's built-in notification screen as illustrated therein. As shown, the display 310 can show live feeds from the camera as described with reference to FIGS. 1 and 2. Selection of buttons 320 may initiate commands to cause the walkway to lift and the release the winch and drive axel. The status indicators 370 may indicate the current status of the sensors. By way of example, the status indicators may show “green” to show that the status conditions of the sensors are being met or they may show “red” should the conditions are not being met. As described with respect to FIG. 1, should a water sensor not detect water, indicating that the water level in a lake is low and therefore the dock needs to be moved, the water level sensor may show “red” and therefore the dock needs to be moved towards the lake. The user may then use the directional arrows 340 to initiate movement of the dock towards or away from the shoreline. Once the dock has been moved to an adequate location, the indicators 370 may then begin to show “green” indicating that the dock is now in a proper location. All the while, the user may monitor the movement of the dock by way of the live feed displayed on the display 310.

Other types of controller devices may be used in place of the mobile device such as general purpose computers, computers, and/or other electronic control devices.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

The invention claimed is:

1. A system for providing an automated means for moving a floating dock to a position in relation to a shoreline of a body of water comprising:
a controller;
at least one sensor having preprogrammed conditions;
at least one manual switch in communication with the controller; and
a live axel assembly, wherein upon detection that the preprogrammed conditions of the sensor are not met, the controller actuating the manual switches to drive the live axel in a direction to meet the sensor condition.

2. The system of claim 1, wherein the system further comprises a camera for providing a live feed to a user for monitoring the positioning of the dock.

3. The system of claim 1, wherein the at least one sensor is a visual, proximity or a water level sensor.

4. The system of claim 2, wherein the system further comprises:
at least one electrically powered winch assembly with cables attaching the floating dock to the shoreline, which allows the floating dock to be repositioned in relation to the shoreline;
a ramp assembly having a pivot arm disposed at one end; and
an anchor assembly, wherein the controller releases the winch assembly, and lifts the ramp and anchor assemblies prior to actuating the manual switches to drive the live axel.

5. A system for providing an automated means for moving a floating dock to a position in relation to a shoreline of a body of water comprising:
a controller;
a remote access network;
a controller device connected in communication with the controller via the remote access, wherein the controller device sends commands through the remote access to the controller to actuate a live axel to reposition the dock in relation to a shoreline.

6. The system of claim 5, wherein the controller device has a display for receiving live feeds from a camera connected to the system.

7. An electrically powered floating dock comprising:
at least one winch assembly securing the floating dock to an anchor point on a shoreline;
an anchor assembly that provides a temporary anchor point at a current location of the floating dock, wherein the anchor assembly is retractable so as to remove the temporary anchor point, thereby allowing the floating dock to be repositioned in a new position in a new location;
a live axle assembly with wheels, wherein the live axle assembly is actuated by directional commands sent from a remote controller device to move the floating dock in a position relative to a shoreline.
